(19) United States
(12) Patent Application Publication
(10) Pub. No.: US 2018/0111232 A1
(43) Pub. Date: Apr. 26, 2018

(54) BRAZING SHEET FORMED FROM ALUMINUM ALLOY

(71) Applicant: KABUSHIKI KAISHA KOBE SEIKO SHO (KOBE STEEL, LTD.), Kobe-shi, Hyogo (JP)

(72) Inventors: Yuji SHIBUYA, Moka-shi (JP); Shimpei KIMURA, Moka-shi (JP); Akihiro TSURUNO, Moka-shi (JP)

(73) Assignee: Kabushiki Kaisha Kobe Seiko Sho (Kobe Steel, Ltd.), Kobe-shi, Hyogo (JP)

(21) Appl. No.: 15/558,655

(22) PCT Filed: Feb. 22, 2016
(86) PCT No.: PCT/JP2016/055090

§ 371 Date: Sep. 15, 2017

(30) Foreign Application Priority Data
Mar. 17, 2015 (JP) 2015-053194

(51) Int. Cl. B23K 35/28; B32B 15/01; C22C 21/08; C22C 21/14; B23K 35/02

(52) U.S. Cl. CPC B23K 35/286; B32B 15/016; B23K 1/0012; C22C 21/14; B23K 35/0238; C22C 21/08

(57) ABSTRACT

Disclosed herein is a brazing sheet made of an aluminum alloy, which can maintain excellent strength after braizing and corrosion resistance even though the sheet is thinned The brazing sheet 1A includes a core material 2, a brazing material 4 provided on at least one side of the core material 2, and an intermediate layer 3 provided between the core material 2 and the brazing material 4 on the at least one side, wherein the core material 2 includes Cu: 0.50 to 1.10% by mass, Si: 0.10 to 1.10% by mass, and Mn: 0.60 to 2.00% by mass, and Al and inevitable impurities, and the intermediate layer 3 includes Zn: 0.50 to 10.00% by mass, and Si: exceeding 0.20% by mass and 1.10% by mass or less, and Al and inevitable impurities, and wherein the brazing material 4 is made of an AlSi based alloy.

### TECHNICAL FIELD

The present invention relates to a brazing sheet made of an aluminum alloy that is used in automobile heat exchangers.

### BACKGROUND ART

A brazing sheet made of an aluminum alloy, which has a structure in which an intermediate layer and a brazing material cladded on a core material, is used as a plate material for heat exchangers mounted on automobiles. For example, Patent Document 1 proposes a brazing sheet made of an Al alloy, comprising an Al alloy core material comprising Mn: 0.5 to 2.0% by mass (hereinafter simply referred to as %), Cu: 0.1 to 1.0%, Mg: 0 to 1.0%, and Ti: 0 to 0.3%, with the balance being Al and inevitable impurities; an intermediate layer having a thickness of 30 to 150 μm formed from an Al alloy comprising Mn: 0.01 to 2.0%, Zn: 0.05 to 5.0%, and Ti: 0 to 0.3%, and further comprising Mg: regulated to 0.05% or less and Cu: regulated to 0.05% or less, with the balance being Al and inevitable impurities, provided on one or both sides of the Al alloy core material; and an Al—Si based alloy brazing material having a thickness of 30 to 150 μm cladded on the intermediate layer.

### PRIOR ART DOCUMENT

### Patent Document

Patent Document 1: JP H10-158769 A

### SUMMARY OF THE INVENTION

### Problems to be Solved by the Invention

With recent requirements to reduce size and weight of automobiles, heat exchangers have been required to reduce size and weight and to achieve high performance. To realize these requirements, there is a need for a plate material forming heat exchangers to be thinned. There is also a need for the plate material not only to achieve high strength, but also to maintain brazability and corrosion resistance. In a brazing sheet used in a conventional plate material, corrosion resistance is ensured by providing an intermediate layer having a sacrificial anticorrosive function. However, the conventional brazing sheet has a problem that a core material ratio decreases with thinning, and thus it is impossible to maintain strength after brazing by the core material. The conventional brazing sheet also has a problem that, since the strength of the intermediate layer is lower than that of the core material, it is impossible to compensate degradation of the strength after brazing of the thinned brazing sheet only by providing the intermediate layer.

The present invention has been made in view of the foregoing circumstances, and it is an object of the present invention to provide a brazing sheet made of an aluminum alloy, which can maintain excellent strength after brazing and corrosion resistance even though the sheet is thinned.

### Means for Solving the Problems

To solve the foregoing problems, a brazing sheet made of an aluminum alloy according to the present invention is a brazing sheet made of an aluminum alloy, including a core material, a brazing material provided on at least one side of the core material, an intermediate layer provided between the core material the brazing material on the at least one side, wherein the core material includes Cu: 0.50 to 1.10% by mass, Si: 0.10 to 1.10% by mass, and Mn: 0.60 to 2.00% by mass, with the balance being Al and inevitable impurities, and the intermediate layer includes Zn: 0.50 to 10.00% by mass, and Si: exceeding 0.20% by mass and 1.10% by mass or less, with the balance being Al and inevitable impurities, and wherein the brazing material is made of an Al—Si based alloy.

Regarding the brazing sheet made of an aluminum alloy of the present invention, the core material includes predetermined amounts of Cu, Si and Mn, and the intermediate layer includes a predetermined amount of Si, thus the strength after braizing of the brazing sheet is improved. Whereby, it is possible to compensate degradation of the strength after braizing due to thinning of the brazing sheet, namely, decrease of the core material ratio by increasing the strength of the core material and the intermediate layer. When the core material includes a predetermined amount of Cu and the intermediate layer includes a predetermined amount of Zn, a potential difference between the core material and the intermediate layer increases, thus the sacrificial anode effect of the intermediate layer is improved. Whereby, corrosion resistance of the brazing sheet can be maintained even though the intermediate layer is thinned.

Regarding the brazing sheet made of an aluminum alloy according to the present invention, the thickness of the intermediate layer is preferably 0.05 mm or more and preferably 35% or less of the total thickness of the brazing sheet.

Regarding the brazing sheet made of an aluminum alloy of the present invention, when the intermediate layer has a predetermined thickness, strength after braizing and corrosion resistance are further improved.

Regarding the brazing sheet made of an aluminum alloy according to the present invention, the intermediate layer may further include Mn: 0.10 to 1.50% by mass.

Regarding the brazing sheet made of an aluminum alloy of the present invention, when the intermediate layer further includes a predetermined amount of Mn, the strength after braizing of the brazing sheet is improved.

Regarding the brazing sheet made of an aluminum alloy according to the present invention, the core material may further include at least one of Mg: 0.05 to 0.50% by mass, Cr: 0.05 to 0.30% by mass, Ti: 0.05 to 0.30% by mass, and Zr: 0.05 to 0.30% by mass.

Regarding the brazing sheet made of an aluminum alloy of the present invention, when the core material further includes predetermined amounts of at least one of Mg, Cr, Ti and Zr, the strength after braizing of the brazing sheet is improved. When the core material further includes a predetermined amount of Ti, the corrosion resistance of the brazing sheet is improved. When the core material further includes a predetermined amount of Mg, the brazability of the brazing sheet is improved.

Regarding the brazing sheet made of an aluminum alloy according to the present invention, the intermediate layer may further include at least one of Mg: 0.05 to 0.50% by mass, Cr: 0.05 to 0.30% by mass, Ti: 0.05 to 0.30% by mass, and Zr: 0.05 to 0.30% by mass.

Regarding the brazing sheet made of an aluminum alloy of the present invention, when the intermediate layer further includes predetermined amounts of at least one of Mg, Cr, Ti and Zr, the strength after braizing of the brazing sheet is improved. When the intermediate layer further includes a predetermined amount of Ti, the corrosion resistance of the brazing sheet is improved. When the intermediate layer further includes a predetermined amount of Mg, the brazability of the brazing sheet is improved.

### Effects of the Invention

The brazing sheet made of an aluminum alloy according to the present invention can exhibit excellent strength after braizing, corrosion resistance and brazability even though the sheet is thinned.

### BRIEF DESCRIPTION OF THE DRAWINGS

FIG. 1 is a cross-sectional view schematically showing a structure of a brazing sheet made of an aluminum alloy according to the present invention.

FIG. 2 is a cross-sectional view schematically showing another structure of a brazing sheet made of an aluminum alloy according to the present invention.

FIG. 3 is a cross-sectional view schematically showing another structure of a brazing sheet made of an aluminum alloy according to the present invention.

FIG. 4 is a perspective view showing a method for evaluating brazability of a brazing sheet made of an aluminum alloy.

### MODE FOR CARRYING OUT THE INVENTION

A first embodiment of the brazing sheet made of an aluminum alloy according to the present invention (hereinafter referred to as the brazing sheet) will be described below.

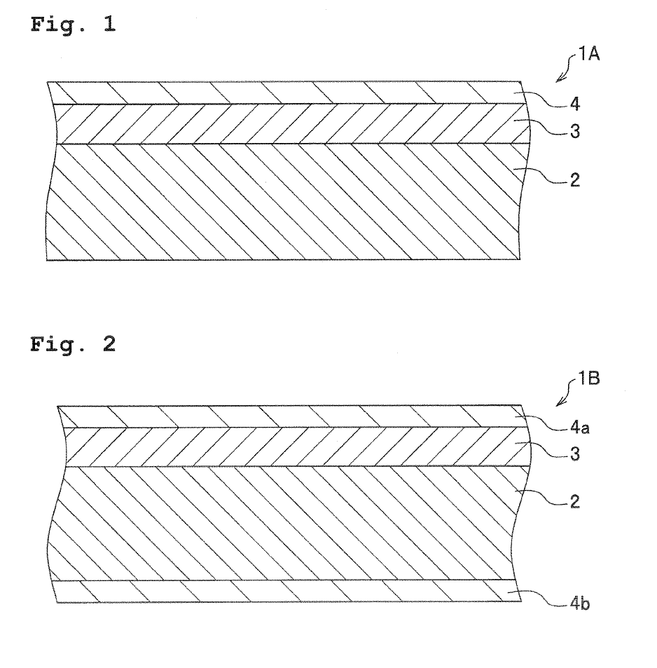

As shown in FIG. 1, a brazing sheet 1A includes a core material 2, a brazing material 4 provided on one side of the core material 2, and an intermediate layer 3 provided between the core material 2 and the brazing material 4. To achieve both the reduction in weight of the brazing sheet 1A and the improvement of the strength after braizing, the total thickness of the brazing sheet 1A is preferably 0.30 to 1.00 mm. In view of reducing the weight by thinning, the total thickness of the sheet is preferably 0.80 mm or less, and more preferably 0.60 mm or less. Each structure will be described below.

### Core Material

The core material 2 is made of an aluminum alloy that includes predetermined amounts of Cu, Si and Mn, with the balance being Al and inevitable impurities. The reason for limiting the numerical value of the composition will be described below.

### Cu in Core Material: 0.50 to 1.10% by Mass

Cu makes the potential of the core material noble and contributes to improving the corrosion resistance and the strength after braizing by solid solution strengthening. When the Cu content is less than 0.50% by mass, the strength after braizing is insufficient. Meanwhile, when the Cu content exceeds 1.10% by mass, a solidus temperature of the core material 2 is decreased, and thus local melting occurs during heating for brazing. Therefore, the Cu content of the core material 2 is 0.50 to 1.10% by mass.

### Si in Core Material: 0.10 to 1.10% by Mass

Si contributes to improving the strength after braizing by solid solution strengthening and dispersion strengthening due to formation of disperse particles with Mn. When the Si content is less than 0.10% by mass, the strength after braizing is insufficient. Meanwhile, when the Si content exceeds 1.10% by mass, the solidus temperature of the core material 2 is decreased, whereby, local melting occurs during heating for brazing. Thus, the Si content of the core material 2 is 0.10 to 1.10% by mass. In view of improving the strength after braizing of the core material 2, the lower limit of the Si content preferably exceeds 0.20% by mass and the upper limit is preferably 1.00% by mass or less.

### Mn in Core Material: 0.60 to 2.00% by Mass

Mn forms disperse particles with Si, leading to dispersion strengthening, thus contributing to improving the strength after braizing. When the Mn content is less than 0.60% by mass, the strength after braizing is insufficient. Meanwhile, when the Mn content exceeds 2.00% by mass, coarse intermetallic compounds are formed during casting, thereby workability degrades, thus it is difficult to roll the material. Therefore, the Mn content of the core material 2 is 0.60 to 2.00% by mass.

### Balance of Core Material: Al and Inevitable Impurities

The components of the core material 2 include the balance being Al and inevitable impurities, in addition to the components mentioned above. Note that the inevitable impurities can include, for example, Fe, Zn and the like. The Fe content is 0.70% by mass or less, and preferably 0.50% by mass or less. The Zn content is 0.10% by mass or less. As long as the contents of these elements are limited in this way, the core material 2 can be allowed to include these components without interrupting the effects of the present invention.

The core material 2 may further include, as the component, predetermined amounts of at least one of Mg, Cr, Ti and Zr. The reason for limiting the numerical value of the Mg content will be described below.

### Mg in Core Material: 0.05 to 0.50% by Mass

Mg forms precipitated phase with Si after brazing, leading to precipitation strengthening, thus contributing to improving the strength after braizing. When the Mg content is less than 0.05% by mass, the effect of improving the strength after braizing may be insufficient. Meanwhile, when the Mg content exceeds 0.50% by mass, in case a brazing material is directly arranged on one side of the core material 2 or a bonding member exists, Mg diffused during brazing reacts with a flux to form high melting point compounds, and a function of the flux is impaired, thus the brazability degrades. Therefore, when Mg is included in the core material 2, the Mg content is 0.05 to 0.50% by mass. To obtain stable brazability, the upper limit of the Mg content is preferably 0.30% by mass or less.

### Cr in Core Material: 0.05 to 0.30% by Mass

Cr forms Al₃Cr disperse particles, leading to dispersion strengthening, thus contributing to improving the strength after braizing. When the Cr content is less than 0.05% by mass, the effect of improving the strength after braizing may be insufficient. Meanwhile, when the Cr content exceeds 0.30% by mass, coarse intermetallic compounds are formed during casting, and workability degrades, thus it is difficult to roll the material. Therefore, when Cr is included in the core material 2, the content of Cr is 0.05 to 0.30% by mass.

### Ti in Core Material: 0.05 to 0.30% by Mass

Ti is distributed in the form of layer in an aluminum alloy and thus a corrosion form of the core material 2 becomes a layer form, thereby enabling the reduction in progression speed of corrosion in the thickness direction, thus contributing to improving the corrosion resistance. When the Ti content is less than 0.05% by mass, it may be impossible to obtain the sufficient effect of improving the corrosion resistance. Meanwhile, when the Ti content exceeds 0.30% by mass, coarse intermetallic compounds are easily formed during casting, and workability degrades, thus it is difficult to roll the material. Therefore, when Ti is included in the core material 2, the content of Ti is 0.05 to 0.30% by mass.

### Zr in Core Material: 0.05 to 0.30% by Mass

Zr forms Al₃Zr disperse particles, leading to dispersion strengthening, thus contributing to improving the strength after braizing. When the Zr content is less than 0.05% by mass, the effect of improving the strength after braizing may be insufficient. Meanwhile, when the Zr content exceeds 0.30% by mass, coarse intermetallic compounds are formed during casting, workability degrades, thus it is difficult to roll the material. Therefore, when Zr is included in the core material 2, the content of Zr is 0.05 to 0.30% by mass.

When the core material 2 includes, as the component, at least one of Mg, Cr, Ti and Zr, in view of improving the strength after braizing and corrosion resistance, the total amount of the components included is preferably 0.05 to 0.50% by mass.

### Intermediate Laver

The intermediate layer 3 is made of an aluminum alloy that includes predetermined amounts of Zn and Si, with the balance being Al and inevitable impurities. The reason for limiting the numerical value of the composition of the intermediate layer 3 will be described

### Zn in Intermediate Layer: 0.50 to 10.00% by Mass

Zn makes the corrosion potential of the intermediate layer 3 base, causing a difference in potential between the intermediate layer 3 and the core material 2, contributing to improving the corrosion resistance. When the Zn content is less than 0.50% by mass, the difference in potential between the intermediate layer 3 and the core material 2 decreases, thus it is difficult to ensure the corrosion resistance. Meanwhile, when the Zn content exceeds 10.00% by mass, a difference in potential between the intermediate layer and the core material 2 becomes excessive, and the intermediate layer 3 is early wasted, as a result, the sacrificial anode effect is degraded. Therefore, the Zn content in the intermediate layer 3 is 0.50 to 10.00% by mass. In view of improving the corrosion resistance of the intermediate layer 3, the lower limit of the Zn content is preferably 2.50% by mass and the upper limit is preferably 6.00% by mass.

### Si in Intermediate Layer: Exceeding 0.20% by Mass and 1.10% by Mass or Less

Si contributes to improving the strength after braizing by solid solution strengthening. When the intermediate layer 3 includes Mn, Si contributes to improving the strength after braizing by dispersion strengthening due to formation of disperse particles of Si with Mn. When the Si content is 0.20% by mass or less, the strength after braizing is insufficient. Meanwhile, when the Si content exceeds 1.10% by mass, a solidus temperature of intermediate layer 3 is decreased and thus local melting occurs during heating for brazing, the corrosion resistance degrades. Therefore, the Si content of the intermediate layer 3 exceeds 0.20% by mass and 1.10% by mass or less.

In view of improving the strength of the intermediate layer 3, the upper limit of the Si content is preferably 1.00% by mass.

### Balance in Intermediate Layer: Al and Inevitable Impurities

The components of the intermediate layer 3 include the balance being Al and inevitable impurities, in addition to the components mentioned above. The inevitable impurities can include, for example, Fe, In, Sn, Ni and the like. The Fe content is 0.70% by mass or less, and preferably 0.50% by mass or less. The content of each of elements other than Fe is less than 0.05% by mass, and preferably 0.03% by mass or less. As long as the contents of these elements are limited in this way, the intermediate layer 3 can be allowed to include these components without interrupting the effects of the present invention.

The intermediate layer 3 preferably has a predetermined thickness. The reason for limiting the numerical value of the thickness of the intermediate layer 3 will be described below.

### Thickness of Intermediate Layer: 0.05 mm or More and 35% or Less of Total Thickness of Sheet

The intermediate layer 3 is arranged as a sacrificial anticorrosion layer between the core material 2 and the brazing material 4. When the thickness of the intermediate layer 3 is less than 0.05 mm, it may be impossible to sufficiently improve the corrosion resistance due to lacking in the amount of the sacrificial anticorrosion layer. Meanwhile, when the thickness of the intermediate layer 3 exceeds 35% of the total thickness of a brazing sheet 1A, namely, a clad rate of the intermediate layer 3 exceeds 35%, a ratio of the core material 2 relative to the total thickness of the sheet may be decreased, thus it may be impossible to sufficiently improve the strength after braizing. In view of improving the corrosion resistance, the lower limit of the thickness of the intermediate layer 3 is preferably 0.07 mm. In view of improving the strength after braizing, the upper limit of the thickness of the intermediate layer 3 is preferably 35% of the total thickness of the sheet, namely, a clad rate of the intermediate layer is preferably 35% or less.

The intermediate layer 3 may further include, as the component, a predetermined amount of Mn. The reason for limiting the numerical value of the Mn content will be described below.

### Mn in Intermediate Layer: 0.10 to 1.50% by Mass

Mn forms disperse particles with Si, leading to dispersion strengthening, thus contributing to improving the strength after braizing. then the Mn content is less than 0.10% by mass, the effect of improving the strength after braizing may be insufficient. Meanwhile, when the Mn content exceeds 1.50% by mass, coarse intermetallic compounds are formed during casting, and workability degrades, thus it is difficult to roll the material. Therefore, when Mn is included in the intermediate layer 3, the content of Mn is 0.10 to 1.50% by mass.

The intermediate layer 3 may further include, as the component, predetermined amounts of at least one of Mg, Cr, Ti and Z. The reason for limiting the numerical value of Mg and the like will be described below.

### Mg in Intermediate Layer: 0.05 to 0.50% by Mass

Mg forms precipitation phase with Si after brazing, leading to precipitation strengthening, thus contributing to improving the strength after braizing. When the Mg content is less than 0.05% by mass, the effect of improving the strength after braizing may be insufficient. Meanwhile, when the Mg content exceeds 0.50% by mass, Mg diffused to the brazing material side during brazing reacts with a flux to form high melting point compounds, a function of the flux is impaired, thus the brazability degrades. Therefore, when Mg is included in the intermediate layer, the Mg content is 0.05 to 0.50% by mass. To obtain stable brazability, the upper limit of the Mg content is preferably 0.30% by mass or less.

### Cr in Intermediate Layer: 0.05 to 0.30% by Mass

Cr forms Al₃Cr disperse particles, leading to dispersion strengthening, thus contributing to improving the strength after braizing. When the Cr content is less than 0.05% by mass, the effect of improving the strength after braizing may be insufficient. Meanwhile, when the Cr content exceeds 0.30% by mass, coarse intermetallic compounds are formed during casting, and workability degrades, thus it is difficult to roll the material. Therefore, when Cr is included in the intermediate layer, the content of Cr is 0.05 to 0.30% by mass.

### Ti in Intermediate Layer: 0.05 to 0.30% by Mass

Ti is distributed in the form of layer in an aluminum alloy and thus a corrosion form of the intermediate layer 3 becomes a layer form, thereby enabling the reduction in progression speed of corrosion in the thickness direction, thus contributing to improving the corrosion resistance. When the Ti content is less than 0.05% by mass, it may be impossible to obtain the sufficient effect of improving the corrosion resistance. Meanwhile, when the Ti content exceeds 0.30% by mass, coarse intermetallic compounds are easily formed during casting and workability degrade, thus it is difficult to roll the material. Therefore, when Ti is included in the intermediate layer, the content of Ti is 0.05 to 0.30% by mass.

### Zr in Intermediate Layer: 0.05 to 0.30% by Mass

Zr forms Al₃Zr disperse particles, leading to dispersion strengthening, thus contributing to improving the strength after braizing. When the Zr content is less than 0.05% by mass, the effect of improving the strength after braizing may be insufficient. Meanwhile, when the Zr content exceeds 0.30% by mass, coarse intermetallic compounds are formed during casting, workability degrades, thus it is difficult to roll the material. Therefore, when Zr is included in the intermediate layer, the content of Zr is 0.05 to 0.30% by mass.

When the intermediate layer 3 includes, as the component, at least one of Mg, Cr Ti, and Zr, in view of improving the strength after braizing and corrosion resistance, the total amount of the components is preferably 0.05 to 0.50% by mass.

### Brazing Material

The brazing material 4 is made of an Al—Si based alloy. Examples of the Al—Si based alloy include, but are not particularly limited to, Al—Si based alloys defined in JIS, such as alloy 4343 and alloy 4045. The Al—Si based alloy can include, in addition to an Al alloy including Si, an Al alloy including Zn. That is, the Al—Si based alloy can be any alloy as long as it is an Al—Si based alloy or an Al—Si—Zn based alloy normally used. It is also possible to use an Al—Si—Mg based alloy and an Al—Si—Mg—Bi based alloy that are used for vacuum brazing. The Al—Si based alloy may include Fe, Cu, Mn and the like, in addition to Si, Zn, Mg and Bi.

It is preferred to use, as the brazing material 4, specifically, a brazing material including Si: 4.00 to 13.00% by mass, with the balance being Al and inevitable impurities. In view of ensuring the brazability, the Si content of the brazing material 4 is desirably 7.00 to 12.00% by mass.

In the manufacture of a brazing sheet 1A, a core material, an intermediate layer and a brazing material, which are materials for the brazing sheet 1A, are manufactured. The manufacturing methods for the core material, the intermediate layer and the brazing material are not particularly limited. For example, after casting the aluminum alloy for the core material with the above-mentioned composition at a predetermined casting temperature, ingots obtained are subjected to face milling as needed, followed by homogeneous heat treatment, thus the core material is manufactured. After casting the aluminum alloy for the intermediate layer with the above-mentioned composition and the aluminum alloy for the brazing material with the above-mentioned composition at a predetermined casting temperature, ingots obtained are subjected to face milling as needed, followed by homogeneous heat treatment. Subsequently, hot-rolling is performed to a predetermined thickness, thus the intermediate layer and the brazing material are manufactured.

Thereafter, the intermediate layer is overlapped on one side of the core material, while the brazing material is overlapped on the outer side of the intermediate layer to obtain a laminated sheet material. The laminated sheet material is hot-rolled to press-bond and roll each the layers, then cold-rolled to produce a brazing sheet 1A including a core material 2, an intermediate layer 3 and brazing material 4. In the manufacturing method mentioned above, an annealing step may be performed as necessary during or after the cold-rolling step.

A second embodiment of the brazing sheet according to the present invention will be described below.

As shown in FIG. 2, a brazing sheet 1B includes a core material 2, a first brazing material 4a provided on one side of the core material 2, a second brazing material 4b provided on the other side of the core material 2, and an intermediate layer 3 provided between the core material 2 and the first brazing material 4a. The total thickness of the brazing sheet 1B is the same as that of the brazing sheet 1A. Each structure will be described below.

The composition and the thickness of the core material 2 are the same those as mentioned above. The composition and the thickness of the first and second brazing materials 4a and 4b are the same as those of the brazing material 4. The composition and the thickness of the intermediate layer 3 are the same as those mentioned above. The material and the thickness of the first brazing material 4a and those of the second brazing material 4b may be the same as or different from each other.

A third embodiment of the brazing sheet according to the present invention will be described.

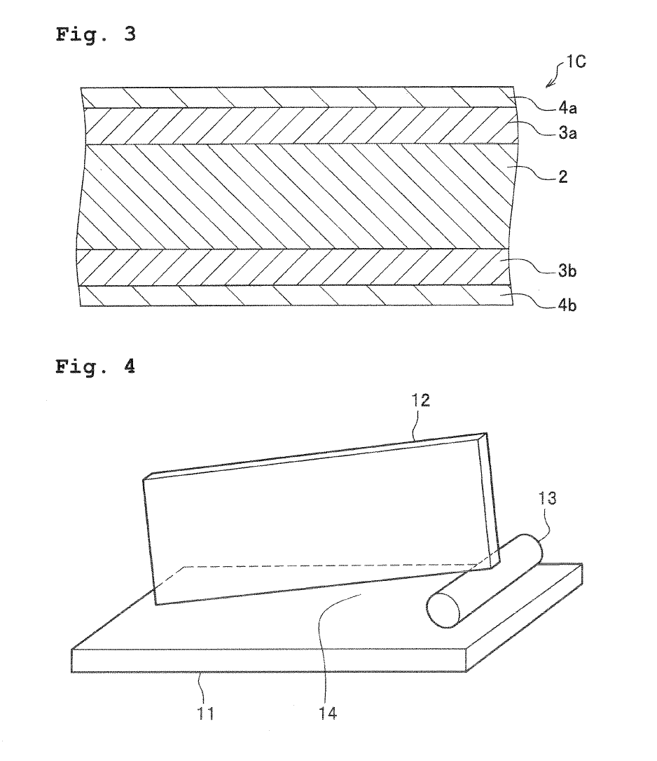

As shown in FIG. 3, the brazing sheet 1C includes a core material 2, a first brazing material 4a provided on one side of the core material 2, a second brazing material 4b provided on the other side of the core material 2, a first intermediate layer 3a provided between the core material 2 and the first brazing material 4a, and a second intermediate layer 3b provided between the core material 2 and the second brazing material 4b. The total thickness of the brazing sheet 1C is the same as that of the brazing sheet 1A. Each structure will be described below.

The composition and the thickness of the core material 2 are the same as those mentioned above. The composition and the thickness of the first and second brazing materials 4a and 4b are the same as those of the brazing material 4. The composition and the thickness of the first and second intermediate layers 3a and 3b are the same as those of the intermediate layer 3. In view of improving the corrosion resistance, each thickness of the first intermediate layer 3a and the second intermediate layer 3b is preferably 0.05 mm or more. In view of improving the strength after braizing, the total thickness of the first intermediate layer 3a and the second intermediate layer 3b is preferably 35% or less of the total thickness of the sheet. The material and thickness of the first brazing material 4a and those of the second brazing material 4b may be the same as or different from each other. The material and the thickness of the first intermediate layer 3a and those of the second intermediate layer 3b may be the same as or different from each other.

The manufacturing method of the brazing sheet 1B is the same as the above-mentioned manufacturing method of the brazing sheet 1A, except that the core material, the intermediate layer, the first brazing material and the second brazing material are overlapped with each other to form a laminated sheet material. The manufacturing method of the brazing sheet 1C is the same as the above-mentioned manufacturing method of the brazing sheet 1A, except that the core material, the first intermediate layer, the second intermediate layer, the first brazing material and the second brazing material are overlapped with each other to form a laminated sheet material.

While the brazing sheet and the manufacturing method therefor according to the present invention have been described above, other conditions and the like not specified herein can be those known in the related art to implement the present invention. Such other conditions are not limited as long as they exhibit the effects obtained by the above-mentioned specific conditions.

### EXAMPLES

Examples of the present invention will be described below.

After casting the aluminum alloy for the core material with the composition shown in Table 1, an ingot obtained was subjected to face milling, followed by homogenization heat treatment to produce core materials (Nos. 1 to 16). After casting the aluminum alloy for the intermediate layer with the composition shown in Table 2, an ingot obtained was subjected to face milling, followed by homogenization heat treatment and further hot-rolling to produce intermediate layers (Nos. 1 to 17). After casting the aluminum alloy for the brazing material, including Si: 10.00% by mass, with the balance being Al and inevitable impurities, an ingot obtained was subjected to face milling, followed by homogenization heat treatment and further hot-rolling to produce a brazing material.

TABLE 1

| Core | Composition (% by mass, the balance being Al and | | | | | | |
|---|---|---|---|---|---|---|---|
| material | inevitable impurities) | | | | | | |
| No. | Si | Cu | Mn | Ti | Mg | Cr | Zr |
| 1 | 0.70 | 0.60 | 1.20 | — | — | — | — |
| 2 | 1.00 | 0.70 | 1.20 | — | — | — | — |
| 3 | 0.20 | 0.70 | 1.20 | — | — | — | — |
| 4 | 0.70 | 1.00 | 1.20 | — | — | — | — |
| 5 | 0.70 | 0.50 | 1.20 | 0.20 | — | — | — |
| 6 | 0.50 | 0.60 | 1.90 | 0.10 | — | — | — |
| 7 | 0.70 | 0.70 | 0.80 | 0.10 | — | — | — |
| 8 | 0.70 | 0.70 | 1.20 | — | 0.30 | — | — |
| 9 | 0.80 | 0.80 | 1.40 | — | — | 0.10 | — |
| 10 | 0.70 | 0.70 | 1.20 | — | — | — | 0.20 |
| 11 | 0.05 | 0.50 | 1.00 | — | — | — | — |
| 12 | 0.50 | 0.50 | 0.50 | 0.20 | — | — | — |
| 13 | 0.70 | 0.40 | 1.20 | — | — | — | — |
| 14 | 1.20 | 0.50 | 1.20 | — | — | — | — |
| 15 | 0.50 | 1.20 | 1.40 | — | — | — | — |
| 16 | 0.70 | 0.50 | 2.10 | — | — | — | — |

(Note) The mark “—” indicate that the component is not included.
(Note) The underlined numeral value indicates that the requirements of the present invention are not satisfied.

TABLE 2

| Core | Composition (% by mass, the balance being Al and | | | | | | |
|---|---|---|---|---|---|---|---|
| material | inevitable impurities) | | | | | | |
| No. | Zn | Si | Mn | Ti | Mg | Cr | Zr |
| 1 | 4.00 | 0.50 | — | — | — | — | — |
| 2 | 8.00 | 0.50 | — | — | — | — | — |
| 3 | 1.00 | 0.50 | — | — | — | — | — |
| 4 | 4.00 | 1.00 | — | — | — | — | — |
| 5 | 4.00 | 0.30 | — | — | — | — | — |
| 6 | 6.00 | 0.50 | — | — | — | — | — |
| 7 | 2.50 | 0.60 | — | — | — | — | — |
| 8 | 2.00 | 0.30 | 1.00 | — | — | — | — |
| 9 | 4.00 | 0.40 | — | — | — | 0.20 | — |
| 10 | 1.00 | 0.60 | — | 0.20 | — | — | — |
| 11 | 3.00 | 0.60 | — | — | — | — | 0.20 |
| 12 | 4.00 | 0.50 | — | — | 0.20 | — | — |
| 13 | 4.00 | 0.60 | — | — | — | 0.10 | 0.10 |
| 14 | 0.20 | 0.60 | — | — | — | — | — |
| 15 | 1.00 | 0.10 | 1.00 | — | — | — | — |
| 16 | 12.00 | 0.50 | — | — | — | — | — |
| 17 | 4.00 | 1.20 | — | — | — | — | — |

(Note) The mark “—” indicate that the component is not included.
(Note) The underlined numeral value indicates that the requirements of the present invention are not satisfied.

The intermediate layer (Nos. 1 to 17) was overlapped on one side of the core material (Nos. 1 to 16), while the brazing material was overlapped on the outer side of the intermediate layer to fabricate a laminated sheet material.

Then, the laminated sheet material was subjected to hot-rolling to press-bond and roll each the layers, then cold-rolled to produce a three-layered brazing sheet 1A (samples Nos. 1 to 38) including the core material 2, the intermediate layer 3 and the brazing material 4 shown in FIG. 1. The layer structure of the brazing sheet 1A is shown in Tables 3 and 4.

The intermediate layer (Nos. 1 and 12) was overlapped on one side of the core material (Nos. 1, 2, and 8), the brazing material was overlapped on the outer side of the intermediate layer (Nos. 1 and 12), and the brazing material was overlapped on the other side of the core material (Nos. 1, 2, and 8) to produce a laminated sheet material. Then, the laminated sheet material was subjected to hot-rolling to press-bond and roll each the layers, then cold-rolled to produce a four-layered brazing sheet 1B (samples Nos. 39 to 42) including the core material 2, the intermediate layer 3, the first brazing material 4a and the second brazing material 4b shown in FIG. 2. The layer structure of the brazing sheet 1B is shown in Table 5.

The intermediate layer (No. 1) was overlapped on one side of the core material (No. 1), the brazing material was overlapped on the outer side of the intermediate layer (No. 1), the intermediate layer (No. 1) was overlapped on the other side of the core material (No. 1), and the brazing material was overlapped on the outer side of the intermediate layer (No. 1) to produce a laminated sheet material. Then, the laminated sheet material was subjected to hot-rolling to press-bond and roll each the layers, then cold-rolled to produce a five-layered brazing sheet 1C (sample No. 43) including the core material 2, the first intermediate layer 3a, the second intermediate layer 3b, the first brazing material 4a and the second brazing material 4b shown in FIG. 3. The layer structure of the brazing sheet 1C is shown in Table 6.

Using the produced brazing sheets (samples Nos. 1 to 43), the strength after braizing, the corrosion resistance on the intermediate layer side, and the brazability were measured and evaluated in the following ways. The results are shown in Tables 3 to 6.

### Strength after Braizing

A heat treatment was applied to each sample material under the conditions simulating the brazing by maintaining at 600° C. for 5 minutes in a nitrogen atmosphere. After maintaining at room temperature for 7 days, the sample material was processed into UIS No. 5 specimens such that a tensile direction is parallel to a rolling direction, and a tensile test was carried out at room temperature to determine the strength after braizing.

Regarding the strength after braizing, sample materials having a tensile strength of 155 MPa or more were rated as being excellent (A); sample materials having a tensile strength of less than 155 MPa and 145 MPa or more were rated as being good (B); and sample materials having a tensile strength of less than 145 MPa were rated as being poor (C).

### Corrosion Resistance on Intermediate Layer Side

After heating (corresponding to brazing) the sample material under a nitrogen atmosphere at 600° C. for 5 minutes, the sample material was processed into a specimen (60 mm in longitudinal width×50 mm in lateral width). Regarding the specimen, masking seals were placed to cover the entire surfaces of the side of the core material 2 shown in FIG. 1 and the side of the second brazing material 4b shown in FIGS. 2 and 3, and the side of the intermediate layer 3 shown in FIG. 1 and FIG. 2 and the side of the first intermediate layer 3a shown in FIG. 3 were regarded as the test surface. Then, an OY water immersion test was performed and evaluation was performed by measuring the depth of corrosion.

This OY water immersion test was performed by the following procedure. That is, after performing a series of operations of immersing the specimen in OY water at 88° C. for 8 hours immersion (supposed to he a state in use) and immersing the specimen in OY water at room temperature for 16 hours (supposed to be state in storage) as one cycle, followed by repeating 60 cycles, maximum depth of corrosion is measured. OY water (Old Yokohama river water) is a corrosion test solution simulating chlorine ions, sulfate ions and the like contained in typical livers of Japan, and the composition (Cl⁻: 195 ppm, SO₄²⁻: 60 ppm, Cu²⁺: 1 ppm, Fe³⁺: 30 ppm) of this OY water is defined (Y. Ando. et. al., SAE Technical Paper 870180(1987)).

Regarding the corrosion resistance on the intermediate layer side, specimens in which the depth of corrosion after the test is less than or equal to the thickness of the intermediate layer were rated as being excellent (A), specimens in which the depth of corrosion exceeds the thickness of the intermediate layer, but corrosion penetrating the thickness did not occur were rated being good (B), and specimens in which corrosion penetrating the thickness occurred were rated being poor (C). The “thickness of the intermediate layer” as used herein means the thickness of the first intermediate layer in sample No. 43. “Penetrating thickness” means that corrosion penetrating the core material 2 occurs in a thickness direction.

### Brazability

Brazability was evaluated by the evaluation method described in “Aluminum Brazing Handbook (revised edition)”, Japan Light Metal Welding & Construction Association (issued March, 2003), written by Tadashi Takemoto et al., pp. 132 to 136. A sample material was processed into a lower sheet (25 mm in longitudinal width×60 mm in lateral width). As shown in FIG. 4, a spacer 13 made of stainless and having a diameter of φ2 mm was interposed between a lower sheet 11 placed horizontally such that a brazing material 4 surface (see FIG. 1) or a first brazing material 4a surface (see FIG. 2 or FIG. 3) was directed upward, and an upper sheet 12 (J1S3003-O material, 2.0 mm in thickness×25 mm in longitudinal width×55 mm in lateral width) placed vertically relative to the lower sheet 11, followed by setting a certain gap 14. The position of the spacer 13 was set at a distance of 50 mm from one end (grounding point to the lower sheet 11) of the upper sheet 12. Regarding the lower sheet 11, a flux (FL-7, manufactured by MORITA CHEMICAL INDUSTRIES CO., LTD.) was applied on both surfaces of the brazing material 4 or both surfaces of the first brazing material 4a at a density of 5 g/m². After performing a heat treatment under a nitrogen atmosphere at 600° C. for 5 minutes, a length of a part in which a gap 14 between the lower sheet 11 and the upper sheet 12 (gap-filling length, namely, length from the grounding point of the upper sheet 12 and the lower sheet 11 to a width direction of the lower sheet 11) was filled by fillet, was measured by a vernier caliper to thereby convert the brazability into numerical values. The brazability of the surface of the second brazing material 4b was measured and evaluated in the same manner as in the surface of the first brazing material 4a.

Samples having the gap-filling length of 25 mm or more were rated as being excellent (A); samples having the gap-filling length of less than 25 mm and 15 mm or more were rated as being good (B); and samples having the gap-filling length of less than 15 mm were rated as being poor (C).

TABLE 3

| | | | | | | | | | | Corrosion resistance | | | |
|---|---|---|---|---|---|---|---|---|---|---|---|---|---|
| | Core material | | Intermediate layer | | | Brazing | | Strength | | on intermediate | | | |
| Sample | Core | | | | Clad | material | Total | after | | layer side | | Brazability (gap- | |
| material | material | Thickness | Intermediate | Thickness | rate | Thickness | thickness | brazing | | (depth of corrosion) | | filling length) | |
| No. | No. | mm | layer No. | mm | % | mm | mm | MPa | Evaluation | μm | Evaluation | mm | Evaluation |
| 1 | 1 | 0.40 | 1 | 0.15 | 25% | 0.05 | 0.60 | 158 | A | 150 | A | 30 | A |
| 2 | 2 | 0.40 | 1 | 0.15 | 25% | 0.05 | 0.60 | 170 | A | 145 | A | 30 | A |
| 3 | 3 | 0.40 | 1 | 0.15 | 25% | 0.05 | 0.60 | 155 | A | 140 | A | 30 | A |
| 4 | 4 | 0.40 | 1 | 0.15 | 25% | 0.05 | 0.60 | 172 | A | 150 | A | 32 | A |
| 5 | 5 | 0.40 | 1 | 0.15 | 25% | 0.05 | 0.60 | 156 | A | 150 | A | 30 | A |
| 6 | 6 | 0.40 | 1 | 0.15 | 25% | 0.05 | 0.60 | 156 | A | 145 | A | 30 | A |
| 7 | 7 | 0.40 | 1 | 0.15 | 25% | 0.05 | 0.60 | 162 | A | 150 | A | 28 | A |
| 8 | 8 | 0.40 | 1 | 0.15 | 25% | 0.05 | 0.60 | 186 | A | 150 | A | 30 | A |
| 9 | 9 | 0.40 | 1 | 0.15 | 25% | 0.05 | 0.60 | 169 | A | 140 | A | 30 | A |
| 10 | 10 | 0.40 | 1 | 0.15 | 25% | 0.05 | 0.60 | 165 | A | 145 | A | 30 | A |
| 11 | 1 | 0.40 | 2 | 0.15 | 25% | 0.05 | 0.60 | 162 | A | 250 | B | 30 | A |
| 12 | 1 | 0.40 | 3 | 0.15 | 25% | 0.05 | 0.60 | 155 | A | 180 | B | 30 | A |
| 13 | 1 | 0.40 | 4 | 0.15 | 25% | 0.05 | 0.60 | 162 | A | 145 | A | 28 | A |
| 14 | 1 | 0.40 | 5 | 0.15 | 25% | 0.05 | 0.60 | 153 | B | 150 | A | 30 | A |
| 15 | 1 | 0.40 | 6 | 0.15 | 25% | 0.05 | 0.60 | 160 | A | 140 | A | 32 | A |
| 16 | 1 | 0.40 | 7 | 0.15 | 25% | 0.05 | 0.60 | 157 | A | 145 | A | 30 | A |
| 17 | 1 | 0.40 | 8 | 0.15 | 25% | 0.05 | 0.60 | 156 | A | 160 | B | 30 | A |
| 18 | 1 | 0.40 | 9 | 0.15 | 25% | 0.05 | 0.60 | 158 | A | 150 | A | 32 | A |
| 19 | 1 | 0.40 | 10 | 0.15 | 25% | 0.05 | 0.60 | 155 | A | 180 | B | 30 | A |
| 20 | 1 | 0.40 | 11 | 0.15 | 25% | 0.05 | 0.60 | 159 | A | 145 | A | 32 | A |
| 21 | 1 | 0.40 | 12 | 0.15 | 25% | 0.05 | 0.60 | 164 | A | 150 | A | 22 | B |
| 22 | 1 | 0.40 | 13 | 0.15 | 25% | 0.05 | 0.60 | 160 | A | 145 | A | 32 | A |
| 23 | 1 | 0.37 | 1 | 0.18 | 30% | 0.05 | 0.60 | 155 | A | 175 | A | 28 | A |
| 24 | 1 | 0.28 | 1 | 0.07 | 18% | 0.05 | 0.40 | 159 | A | 70 | A | 30 | A |
| 25 | 1 | 0.50 | 1 | 0.05 | 8% | 0.05 | 0.60 | 161 | A | 80 | B | 26 | A |
| 26 | 1 | 0.80 | 1 | 0.15 | 15% | 0.05 | 1.00 | 160 | A | 140 | A | 30 | A |
| 27 | 1 | 0.32 | 1 | 0.23 | 38% | 0.05 | 0.60 | 150 | B | 200 | A | 30 | A |

TABLE 4

| | | | | | | | | | | Corrosion resistance | | | |
|---|---|---|---|---|---|---|---|---|---|---|---|---|---|
| | Core material | | Intermediate layer | | | Brazing | | Strength | | on intermediate | | | |
| Sample | Core | Thick- | | | Clad | material | Total | after | | layer side | | Brazability (gap- | |
| material | material | ness | Intermediate | Thickness | rate | Thickness | thickness | brazing | | (depth of corrosion) | | filling length) | |
| No. | No. | mm | layer No. | mm | % | mm | mm | MPa | Evaluation | μm | Evaluation | mm | Evaluation |
| 28 | 11 | 0.40 | 1 | 0.15 | 25% | 0.05 | 0.60 | 139 | C | 145 | A | 28 | A |
| 29 | 12 | 0.40 | 1 | 0.15 | 25% | 0.05 | 0.60 | 143 | C | 145 | A | 30 | A |
| 30 | 13 | 0.40 | 1 | 0.15 | 25% | 0.05 | 0.60 | 143 | C | 150 | A | 30 | A |
| 31 | 14 | 0.40 | 1 | 0.15 | 25% | 0.05 | 0.60 | — | | | | | |
| 32 | 15 | 0.40 | 1 | 0.15 | 25% | 0.05 | 0.60 | — | | | | | |
| 33 | 16 | 0.40 | 1 | 0.15 | 25% | 0.05 | 0.60 | — | | | | | |
| 34 | 1 | 0.40 | 14 | 0.15 | 25% | 0.05 | 0.60 | 154 | B | Penetration | C | 30 | A |
| 35 | 1 | 0.40 | 15 | 0.15 | 25% | 0.05 | 0.60 | 142 | C | 140 | A | 30 | A |
| 36 | 1 | 0.40 | 16 | 0.15 | 25% | 0.05 | 0.60 | 167 | A | Penetration | C | 28 | A |
| 37 | 1 | 0.40 | 17 | 0.15 | 25% | 0.05 | 0.60 | 164 | A | Penetration | C | 30 | A |
| 38 | 11 | 0.40 | 15 | 0.15 | 25% | 0.05 | 0.60 | 138 | C | 150 | A | 28 | A |

(Note) The underlined numeral value indicates that the requirements of the present invention are not satisfied.
(Note) The mark “—” indicates that evaluation could not be performed because local melting occurred or rolling of material was difficult.

TABLE 5

| | Core material | | Intermediate layer | | | First brazing | Second brazing | |
|---|---|---|---|---|---|---|---|---|
| Sample | Core | | First | | Clad | material | material | Total |
| material | material | Thickness | intermediate | Thickness | rate | Thickness | Thickness | thickness |
| No. | No. | mm | layer No. | mm | % | mm | mm | mm |
| 39 | 1 | 0.40 | 1 | 0.15 | 23% | 0.05 | 0.05 | 0.65 |
| 40 | 2 | 0.40 | 1 | 0.15 | 23% | 0.05 | 0.05 | 0.65 |
| 41 | 8 | 0.40 | 1 | 0.15 | 23% | 0.05 | 0.05 | 0.65 |
| 42 | 1 | 0.40 | 12 | 0.15 | 23% | 0.05 | 0.05 | 0.65 |

| | | | Corrosion | | | | | |
|---|---|---|---|---|---|---|---|---|
| | | | resistance on | | | | | |
| | | | intermediate | | Brazability of | | Brazability of | |
| | | | layer | | first brazing | | second brazing | |
| Sample | Strength after | | side (depth of | | material (gap- | | material (gap- | |
| material | brazing | | corrosion) | | filling length) | | filling length) | |
| No. | MPa | Evaluation | μm | Evaluation | mm | Evaluation | mm | Evaluation |
| 39 | 159 | A | 150 | A | 30 | A | 30 | A |
| 40 | 172 | A | 140 | A | 28 | A | 30 | A |
| 41 | 189 | A | 150 | A | 30 | A | 20 | B |
| 42 | 167 | A | 145 | A | 20 | B | 28 | A |

TABLE 6

| | | | | | | | | | First |
|---|---|---|---|---|---|---|---|---|---|
| | Core material | | First intermediate layer | | | Second intermediate layer | | | brazing |
| Sample | Core | | First | | Clad | Second | | Clad | material |
| material | material | Thickness | intermediate | Thickness | rate | intermediate | Thickness | rate | Thickness |
| No. | No. | mm | layer No. | mm | % | layer No. | mm | % | mm |
| 43 | 1 | 0.40 | 1 | 0.15 | 21% | 1 | 0.05 | 7% | 0.05 |

| | | | | | Corrosion | | | | | |
|---|---|---|---|---|---|---|---|---|---|---|
| | | | | | resistance | | | | | |
| | | | | | on first | | | | | |
| | Second | | | | intermediate | | Brazability of | | Brazability of | |
| | brazing | | Strength | | layer side | | first brazing | | second brazing | |
| Sample | material | Total | after | | (depth | | material (gap- | | material (gap- | |
| material | Thickness | thickness | brazing | | of corrosion) | | filling length) | | filling length) | |
| No. | mm | mm | MPa | Evaluation | μm | Evaluation | mm | Evaluation | mm | Evaluation |
| 43 | 0.05 | 0.70 | 157 | A | 140 | A | 30 | A | 30 | A |

As shown in Tables 3, 5 and 6, sample materials Nos. 1 to 27 and 39 to 43 (Examples) satisfying the requirements of the present invention were excellent in strength after braizing, corrosion resistance on the intermediate layer side, and brazability.

Meanwhile, as shown in Table 4, sample materials Nos. 28 to 38 not satisfying the requirements of the present invention were inferior to Examples, as shown below.

Specifically, sample material No. 28 (Comparative Example) was inferior in strength after braizing since the Si content of the core material is less than the lower limit. Sample material No. 29 (Comparative Example) was inferior in strength after braizing since the Mn content of the core material is less than the lower limit. Sample material No. 30 (Comparative Example) was inferior in strength after braizing since the Cu content of the core material is less than the lower limit. Local melting occurred in sample material No. 31 (Comparative Example) since the Si content of the core material exceeds the upper limit. Local melting occurred in sample material No. 32 (Comparative Example) since the Cu content of the core material exceeds the upper limit. Sample material No. 33 (Comparative Example) was not easily rolled since the Mn content of the core material exceeds the upper limit.

Sample material No. 34 (Comparative Example) was inferior in corrosion resistance on the intermediate layer side since the Zn content of the intermediate layer is less than the lower limit. Sample material No. 35 (Comparative Example) was inferior in strength after braizing since the Si content of the intermediate layer is less than the lower limit. Sample material No. 36 (Comparative Example) was inferior in corrosion resistance on the intermediate layer side since the Zn content of the intermediate layer exceeds the upper limit. Local melting occurred in sample material No. 37 (Comparative Example), and the corrosion resistance on the intermediate layer side degrades, since the Si content of the intermediate layer exceeds the upper limit.

Sample material No. 38 (Comparative Example) was inferior in strength after braizing since both of the Si content of the core material and the Si content of the intermediate layer are less than the lower limit.

The present invention includes the following aspects.

### First Aspect

A brazing sheet made of an aluminum alloy including a core material, a brazing material provided on at least one side of the core material, an intermediate layer provided between the core material and the brazing material on the at least one side, wherein

the core material includes Cu: 0.50 to 1.10% by mass, Si: 0.10 to 1.10% by mass, and Mn: 0.60 to 2.00% by mass, with the balance being Al and inevitable impurities, and the intermediate layer includes Zn: 0.50 to 10.00% by mass, and Si: exceeding 0.20% by mass and 1.10% by mass or less, with the balance being Al and inevitable impurities, and wherein

the brazing material is made of an Al—Si based alloy.

### Second Aspect

The brazing sheet made of an aluminum alloy according to the first aspect, wherein a thickness of the intermediate layer is 0.05 mm or more and 35% or less of the total thickness of the brazing sheet.

### Third Aspect

The brazing sheet made of an aluminum alloy according to the first or second aspect, wherein the intermediate layer further includes Mn: 0.10 to 1.50% by mass.

### Fourth Aspect

The brazing sheet made of an aluminum alloy according to any one of the first to third aspects, wherein the core material further includes at least one of Mg: 0.05 to 0.50% by mass, Cr: 0.05 to 0.30% by mass, Ti: 0.05 to 0.30% by mass, and Zr: 0.05 to 0.30% by mass.

### Fifth Aspect

The brazing sheet made of an aluminum alloy according to any one of the first to fourth aspects, wherein the intermediate layer further includes at least one of Mg: 0.05 to 0.50% by mass, Cr: 0.05 to 0.30% by mass, Ti: 0.05 to 0.30% by mass, and Zr: 0.05 to 0.30% by mass.

The application claims priority to Japanese Patent Application No. 2015-053194 filed on Mar. 17, 2015, the disclosure of the application is incorporated by reference.

### DESCRIPTION OF REFERENCE NUMERALS

1A, 1B, 1C: Brazing sheet
2: Core material
3: Intermediate layer
3a: First intermediate layer
3b: Second intermediate layer
4: Brazing material
4a: First brazing material
4b: Second brazing material

1. A brazing sheet comprising an aluminum alloy, said aluminum alloy comprising a core material, a brazing material provided on at least one side of the core material, an intermediate layer provided between the core material and the brazing material on the at least one side,
wherein:
the core material comprises:
Cu: 0.50 to 1.10% by mass,
Si: 0.10 to 1.10% by mass,
Mn: 0.60 to 2.00% by mass, and
Al and inevitable impurities; and
the intermediate layer comprises:
Zn: 0.50 to 10.00% by mass,
Si: exceeding 0.20% by mass and 1.10% by mass or less, and
Al and inevitable impurities;
a thickness of the intermediate layer is 0.05 mm or more; and wherein
the brazing material comprises an Al—Si based alloy.

2. The brazing sheet according to claim 1, wherein a thickness of the intermediate layer is 35% or less of a total thickness of the brazing sheet.

3. The brazing sheet according to claim 1, wherein the intermediate layer further comprises:
Mn: 0.10 to 1.50% by mass.

4. The brazing sheet according to claim 1, wherein the core material further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

5. The brazing sheet according to claim 1, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

6. The brazing sheet according to claim 2, wherein the intermediate layer further comprises Mn: 0.10 to 1.50% by mass.

7. The brazing sheet according to claim 2, wherein the core material further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

8. The brazing sheet according to claim 3, wherein the core material further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

9. The brazing sheet according to claim 5, wherein the core material further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

10. The brazing sheet according to claim 2, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

11. The brazing sheet according to claim 3, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

12. The brazing sheet according to claim 4, wherein the intermediate layer further comprises at least one of
Mg: 0.05 to 0.50% by mass,
Cr: 0.05 to 0.30% by mass,
Ti: 0.05 to 0.30% by mass, and
Zr: 0.05 to 0.30% by mass.

13. The brazing sheet according to claim 6, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

14. The brazing sheet according to claim 7, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

15. (New.): The brazing sheet according to claim 8, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.

16. The brazing sheet according to claim 9, wherein the intermediate layer further comprises at least one of:
Mg: 0.05 to 0.50% by mass,
Cr: 0.05 to 0.30% by mass,
Ti: 0.05 to 0.30% by mass, and
Zr: 0.05 to 0.30% by mass.
